(19) United States
(12) Patent Application Publication
(10) Pub. No.: US 2014/0284120 A1
(43) Pub. Date: Sep. 25, 2014

(54) DUMP TRUCK

(71) Applicant: AEROSPACE HEAVY INDUSTRY EQUIPMENT CO., LTD., Wuhan (CN)

(72) Inventors: Jingwu CAO, Wuhan (CN); Daiyou XU, Wuhan (CN); Rongnan WANG, Wuhan (CN); Xianbing TANG, Wuhan (CN); Minliang CUI, Wuhan (CN); Kai YANG, Wuhan (CN)

(21) Appl. No.: 14/300,184

(22) Filed: Jun. 9, 2014

Related U.S. Application Data
(63) Continuation-in-part of application No. PCT/CN2012/085505, filed on Nov. 29, 2012.

(30) Foreign Application Priority Data
Dec. 27, 2011 (CN) 201110444254.9

(51) Int. Cl. B60G 5/00; B62D 7/14

(52) U.S. Cl. CPC B60G 5/00; B62D 7/144
USPC 180/24.07; 280/98

(57) ABSTRACT

A dump truck including a suspension system and a steering system. The suspension system includes a frame and a plurality of hydraulic suspensions, and every two of the hydraulic suspensions are aligned on one axle. The suspension system includes at least two axles. The frame includes a middle box beam and spars protruding from two sides of the middle box beam. The hydraulic suspensions include a pivotal bearing, rotating frame, swing arm, hanging cylinder, oscillating axle, and wheels. The upper end of the rotating frame is arranged in the lower surface of the spar of the frame via the pivotal bearing. The upper end of the rotating frame is non-rigidly connected to the swing arm. A cylindrical pin is disposed at the front end of the swing arm. The cylindrical pin is sleeved in a pinhole of the oscillating axle.

### CROSS-REFERENCE TO RELATED APPLICATIONS

This application is a continuation-in-part of International Patent Application No. PCT/CN2012/085505 with an international filing date of Nov. 29, 2012, designating the United States, now pending, and further claims priority benefits to Chinese Patent Application No. 201110444254.9 filed Dec. 27, 2011, and to Chinese Patent Application No. 201120554557.1 filed Dec. 27, 2011. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a dump truck, and more particularly to a dump truck used in an open coal mine for coal transportation.

2. Description of the Related Art

Typically, a mine dump truck has the following defects: 1) the truck is bulky, and has large loading capacity, a small number of tires, large tire diameter, high center of gravity, so it is prone to overturn; 2) due to the above-mentioned reasons, the bearing pressure of the ground is large, and thus the truck has high requirement on the road quality; 3) the truck has a large turning radius thereby resulting in poor trafficability; 4) large diameter of tires of the truck causes high production costs and inconvenient transportation, storage, and replacement; 5) the axle load of the truck is large, which demands a high requirement on the axle and the reducing mechanism, thereby increasing the product costs; and 6) the truck adopts a rear axle drive, the rear axle bears more than 60% of loading, so the rear axle tires wear down quickly.

### SUMMARY OF THE INVENTION

In view of the above-described problems, it is one objective of the invention to provide a dump truck featuring high safety and trafficability, and low usage and maintenance costs.

To achieve the above objective, in accordance with one embodiment of the invention, there is provided a dump truck comprising a suspension system and a steering system. The suspension system comprises a frame and a plurality of hydraulic suspensions, and every two of the hydraulic suspensions are aligned on one axle. The suspension system comprises at least two axles; the frame comprises a middle box beam and spars protruding from two sides of the middle box beam. The hydraulic suspensions comprise a pivotal bearing, rotating frame, swing arm, hanging cylinder, oscillating axle, and wheels; an upper end of the rotating frame is arranged in a lower surface of the spar of the frame via the pivotal bearing. The upper end of the rotating frame is non-rigidly connected to the swing arm via a pin; one end of the hanging cylinder is hinged to a lower end of the rotating frame, and the other end of the hanging cylinder is hinged to a middle of the swing arm; a cylindrical pin is disposed at a front end of the swing arm. The cylindrical pin disposed in the front end of the swing arm is sleeved in a pinhole of the oscillating axle; and the wheels are arranged at two sides of the oscillating axle, respectively.

In a class of this embodiment, the steering system comprises a steering cylinder, a steering drag link, and a steering tie rod; one end of the steering cylinder is hinged to a supporting seat of the frame, and the other end of the steering cylinder is hinged to a steering arm of the rotating frame. The steering drag link is hinged to rotating frames of two left-to-right adjacent hydraulic suspensions; and the steering tie rod is hinged to rotating frames of two front-to-back adjacent hydraulic suspensions.

In a class of this embodiment, the oscillating axles of the hydraulic suspensions on at least one axle are provided with two hub electric motors and two hub reductors, respectively; output ends of the hub electric motors are arranged on input ends of the hub reductors, outer rings of the hub reductors are connected to an axle housing of the oscillating axle, and output ends of the hub reductors are arranged on the wheels. The two hub electric motor can be replaced by two hydraulic motors.

In a class of this embodiment, the suspension system comprises between two and eight axles.

The steering system comprises a front steering mechanism and a rear steering mechanism. The steering can be achieved by the front steering mechanism or the rear steering mechanism. The former results in a motor steering, and the latter results in a splayed steering. Upon splayed steering, the front wheels and the rear wheels splay in opposite directions, which greatly reduces the turn radius of the dump truck.

Advantages according to embodiments of the invention are summarized as follows.

1) The dump truck has low center of gravity, thereby improving the driving safety. With the increase of the number of tires, under the same loading, the wheel diameter is reduced nearly by half. Thus, the height and the center of gravity of the vehicle are reduced, the anti-overturning capability is enhanced, and the driving stability and safety of the dump truck are improved.

2) The decreased wheel load alleviates the ground pressure, and thus the destruction to the ground is reduced.

3) The dump truck can adopt the mode of all-wheel splayed steering, thereby achieving low turn radius and high trafficability.

4) All-wheel drive can be achieved in the dump truck, so the truck can smoothly passes the wet road, muddy road, and uneven road, with good trafficability, cross-country performance, and maneuverability.

5) The all-wheel drive ensures the stress exerted on the tires is even thereby prolonging the service life thereof, and meanwhile improving the maneuverability on sliding road.

6) When one tire, electric motor, or hydraulic suspension is broken down, to raise the corresponding hanging cylinder so that the tire no longer contacts with the ground. Thereafter, the dump truck can be directly driven to a maintenance station without the traction of a tractor, thereby improving the maintenance efficiency and reducing the use cost of the truck.

### BRIEF DESCRIPTION OF THE DRAWINGS

The invention is described hereinbelow with reference to the accompanying drawings, in which:

FIG. 1 is a schematic diagram of a mine dump truck according to one embodiment of the invention;

FIG. 2 is a schematic diagram of axles and a steering mechanism of a mine dump truck according to one embodiment of the invention;

FIG. 3 is a schematic diagram of a hydraulic suspension of a mine dump truck according to one embodiment of the invention; and

FIG. 4 is a schematic diagram of an electric wheel of a mine dump truck according to one embodiment of the invention.

### DETAILED DESCRIPTION OF THE EMBODIMENTS

For further illustrating the invention, experiments detailing a dump truck are described below. It should be noted that the following examples are intended to describe and not to limit the invention.

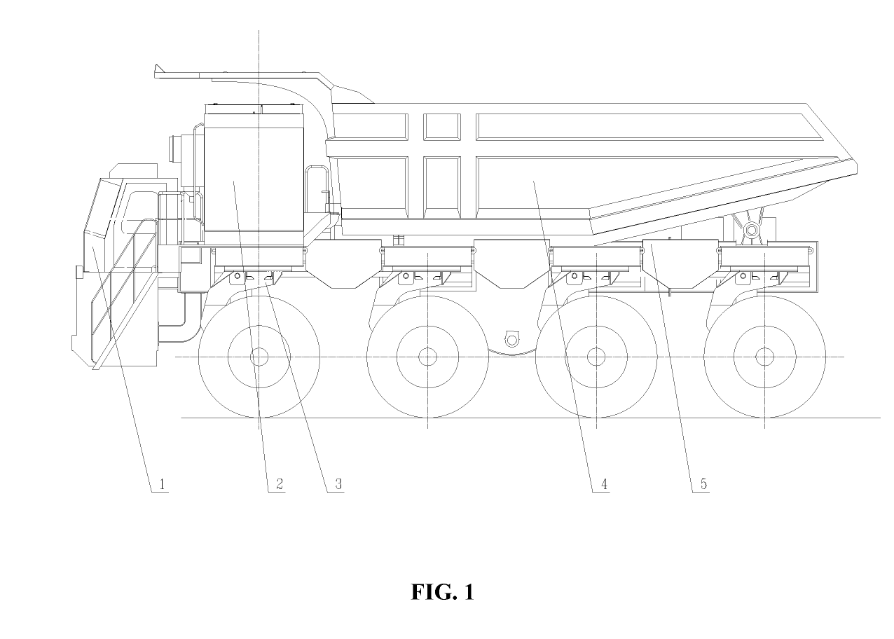

As shown in FIG. 1, the invention provides a mine dump truck featuring all-wheel drive and all-wheel steering. The mine dump truck has a load capacity of 220 tons and four axles. The dump truck comprises a dynamical system 2, a suspension system, a braking system, a steering system, an electric drive, a cab 1, a compartment 4 and a lifting mechanism thereof, and a vehicle integrated management system. Specifically, the suspension system and the steering system are described as follows.

1) Suspension System

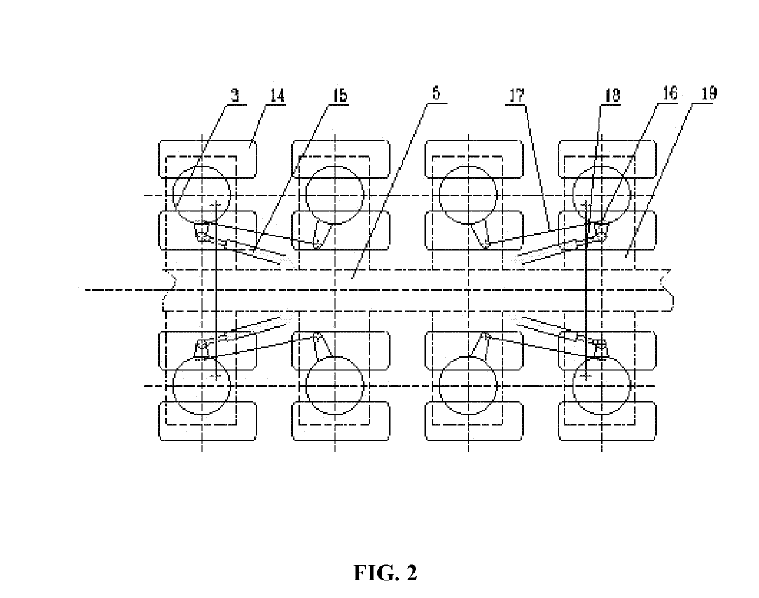

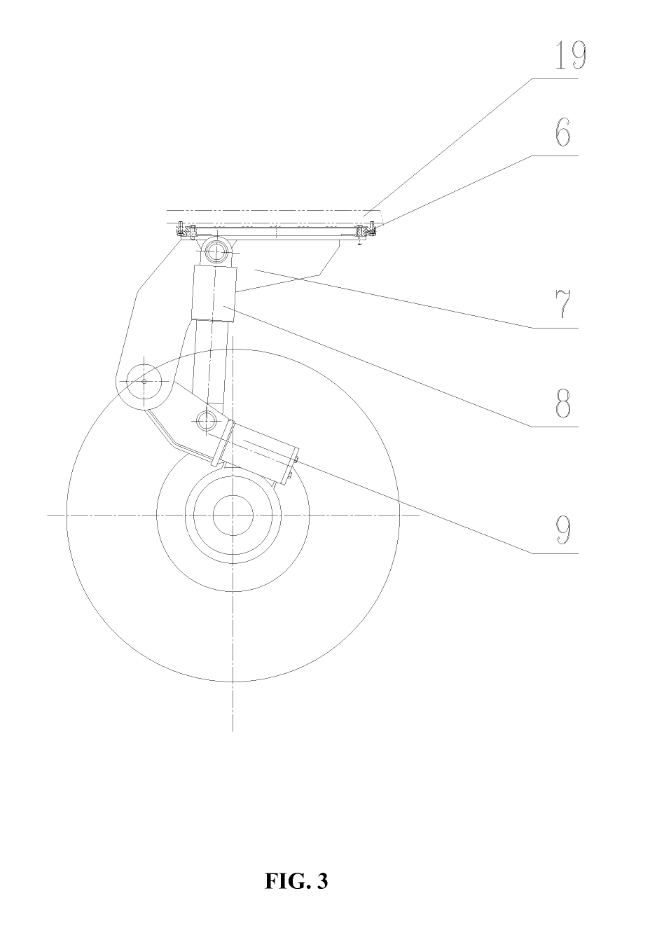

As shown in FIGS. 2 and 3, the suspension system comprises a frame 5 and eight hydraulic suspensions 3. Every two of the hydraulic suspensions are aligned on one axle, and thus the suspension system comprises four axles. The frame 5 comprises a middle box beam and spars 19 protruding from two sides of the middle box beam. The hydraulic suspensions 3 comprise a pivotal bearing 6, rotating frame 7, swing arm 9, hanging cylinder 8, oscillating axle 10, and wheels 14. An upper end of the rotating frame 7 is arranged in a lower surface of the spar 19 of the frame 5 via the pivotal bearing 6. The upper end of the rotating frame 7 is non-rigidly connected to the swing arm 9 via a pin. One end of the hanging cylinder 8 is hinged to a lower end of the rotating frame 7, and the other end of the hanging cylinder is hinged to a middle of the swing arm 9. A cylindrical pin is disposed at a front end of the swing arm 9.

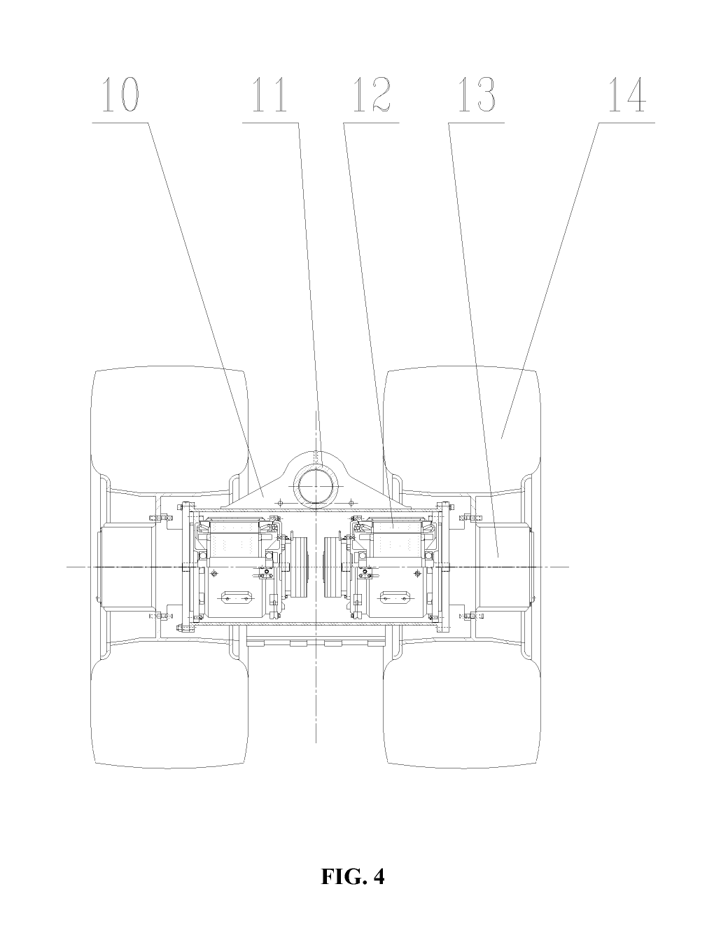

As shown in FIG. 4, the cylindrical pin disposed in the front end of the swing arm 9 is sleeved in a pinhole 11 of the oscillating axle 10. The oscillating axle 10 is capable of rotating in the cylindrical pin, and the swing arm 9 is capable of swinging up and down so that the left and right wheels connected to the oscillating axle 10 adaptively contact with the ground fully. Inside the oscillating axle 10, a hub electric motor 12 and a hub reductor 13 are disposed. The output end of the hub electric motor 12 is arranged on the input end of the hub reductor 13. The outer ring of the hub reductor is connected to an axle housing of the oscillating axle 10, and the output end of the hub reductor 13 is arranged on the wheel 14.

For each axle, two hydraulic suspensions are provided. Thus, whether it is uphill, downhill, or on bumpy roads, or a one-way, two-way cross slope or uneven road surfaces occur, the oscillating axle 10 can adaptively compensate the wheels to yield an even stress. So, the abrasive wear is reduced, the adhesive power is enhanced, and the trafficability and stationarity of the truck are improved.

In this example, the center of gravity of the truck is lowered by about 600 mm in contrast to conventional vehicles.

2) Steering System

The steering system comprises a front steering mechanism and a rear steering mechanism. As shown in FIG. 2, the front/rear steering mechanism comprises a steering cylinder 15, a steering drag link 17, and a steering tie rod 18. To meet the requirement of axle number of the dump truck, each hydraulic suspension is provided with a steering arm 16, and each axle is a steering axle. One end of the steering cylinder 15 is hinged to a supporting seat of the frame 5, and the other end of the steering cylinder 15 is hinged to the steering arm 16 of the rotating frame. The former two axles constitute the front steering mechanism, and the latter two axles constitute the rear steering mechanism. Each steering mechanism comprises two steering cylinders. Thus, four steering cylinders 15 are provided in this example. The dump truck can achieve steering by the front steering mechanism, the rear steering mechanism, or the both. The following describes the working process of the front steering mechanism. When the steering cylinder 15 pushes or pulls the rotating frame 7 of the hydraulic suspension 3 via the steering arm 16, synchronously, the rotating frame 7 drives the steering tie rod 18 hinged thereon to push another rotating frame hinged on the steering tie rod 18 on the same axle. When the two rotating frames on the axle rotate, they push the steering drag link 17 to drive the other two rotating frames on a latter axle to rotate. By the drive of the steering cylinder, the rotating frames of the front steering mechanism rotate to steer the wheels in a desired direction.

The steering system comprises the front steering mechanism and the rear steering mechanism. The steering can be a motor steering or a splayed steering, and has the automatic centring function. As shown in FIG. 2, as needed, when one of the front and the rear steering mechanisms works, it is called motor steering, which is the same as that for normal vehicles. When the front steering mechanism and the rear steering mechanism work simultaneously, it is called splayed steering, the motion patterns of the front steering mechanism and the rear steering mechanism are opposite. Upon steering, the front wheels and the rear wheels splay in opposite directions, so that the dump truck has the minimum turn radius. The steering power of the steering system originates from the steering cylinder, i.e. by the control of the hydraulic pressure. After a long time of splayed steering, the absolute values of the turn angles of the front and rear wheels are not equal. Based on feedback, the steering control system reversely controls the steering cylinder to align automatically, whereby achieving the automatic centring function.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A dump truck, comprising a suspension system and a steering system, wherein
the suspension system comprises a frame and a plurality of hydraulic suspensions, every two of the hydraulic suspensions are aligned on one axle, and the suspension system comprises at least two axles;
the frame comprises a middle box beam and spars protruding from two sides of the middle box beam; the hydraulic suspensions comprise a pivotal bearing, rotating frame, swing arm, hanging cylinder, oscillating axle, and wheels;
an upper end of the rotating frame is arranged in a lower surface of the spar of the frame via the pivotal bearing; the upper end of the rotating frame is non-rigidly connected to the swing arm via a pin; one end of the hanging cylinder is hinged to a lower end of the rotating frame, and the other end of the hanging cylinder is hinged to a middle of the swing arm;
a cylindrical pin is disposed at a front end of the swing arm; the cylindrical pin disposed in the front end of the swing arm is sleeved in a pinhole of the oscillating axle; and
the wheels are arranged at two sides of the oscillating axle, respectively.

2. The dump truck of claim 1, wherein
the steering system comprises a steering cylinder, a steering drag link, and a steering tie rod;
one end of the steering cylinder is hinged to a supporting seat of the frame, and the other end of the steering cylinder is hinged to a steering arm of the rotating frame;
the steering drag link is hinged to rotating frames of two left-to-right adjacent hydraulic suspensions; and
the steering tie rod is hinged to rotating frames of two front-to-back adjacent hydraulic suspensions.

3. The dump truck of claim 1, wherein the oscillating axles of the hydraulic suspensions on at least one axle are provided with two hub electric motors and two hub reductors, respectively; output ends of the hub electric motors are arranged on input ends of the hub reductors, outer rings of the hub reductors are connected to an axle housing of the oscillating axle, and output ends of the hub reductors are arranged on the wheels.

4. The dump truck of claim 2, wherein the oscillating axles of the hydraulic suspensions on at least one axle are provided with two hub electric motors and two hub reductors, respectively; output ends of the hub electric motors are arranged on input ends of the hub reductors, outer rings of the hub reductors are connected to an axle housing of the oscillating axle, and output ends of the hub reductors are arranged on the wheels.

5. The dump truck of claim 1, wherein the suspension system comprises between two and eight axles.

6. The dump truck of claim 2, wherein the suspension system comprises between two and eight axles.
